(19) United States
(12) Patent Application Publication
(10) Pub. No.: US 2017/0308238 A1
(43) Pub. Date: Oct. 26, 2017

(54) ELECTRONIC DEVICE AND METHOD FOR PREVENTING UNINTENDED OPERATION OF ELECTRONIC DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: CAN FANG, Shenzhen (CN)

(21) Appl. No.: 15/368,764

(22) Filed: Dec. 5, 2016

(30) Foreign Application Priority Data
Apr. 26, 2016 (CN) 201610266106.5

(51) Int. Cl. G06F 3/041; G06F 3/0488; G06F 3/0484

(52) U.S. Cl. CPC G06F 3/0418; G06F 2203/04108; G06F 3/04842; G06F 3/0488

(57) ABSTRACT

A method for preventing unintended operations in an electronic device includes detecting whether the electronic device is in response to a predetermined operation. Light intensity is acquired around the electronic device from a light sensor when the electronic device is in response to the predetermined operation. Whether an object presents within a predetermined range from the electronic device is determined when an acquired light intensity is less than a predetermined light intensity. The response to the predetermined operation is suspended and the electronic device is controlled to turn on a reminder mode when an object exists within the predetermined range.

### CROSS-REFERENCE TO RELATED APPLICATIONS

This application claims priority to Chinese Patent Application No. 201610266106.5 filed on Apr. 26, 2016, the contents of which are incorporated by reference herein.

### FIELD

The subject matter herein generally relates to intelligent terminals, and particularly to an electronic device and a method for preventing unintended operation of the electronic device.

### BACKGROUND

Electronic devices such as mobile phones can be portable and lightweight. A user can put the mobile phone in pants pocket or handbag. However, unintentional event may be triggered when the mobile phone is put in the pants pocket or handbag. For example, a message may be sent to a contact person of the mobile phone by unintentional touch on the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

Moreover, in the drawings, like reference numerals designate corresponding parts throughout the several views.

FIG. 1 shows an exemplary embodiment of an electronic device including a preventive system to avoid unintended operations.

FIG. 2 illustrates a user interface of the preventive system of FIG. 1.

FIG. 3 illustrates a flowchart of an exemplary embodiment of a method for controlling the electronic device of FIG. 1 to reduce accidental operations.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” exemplary embodiment in this disclosure are not necessarily to the same exemplary embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

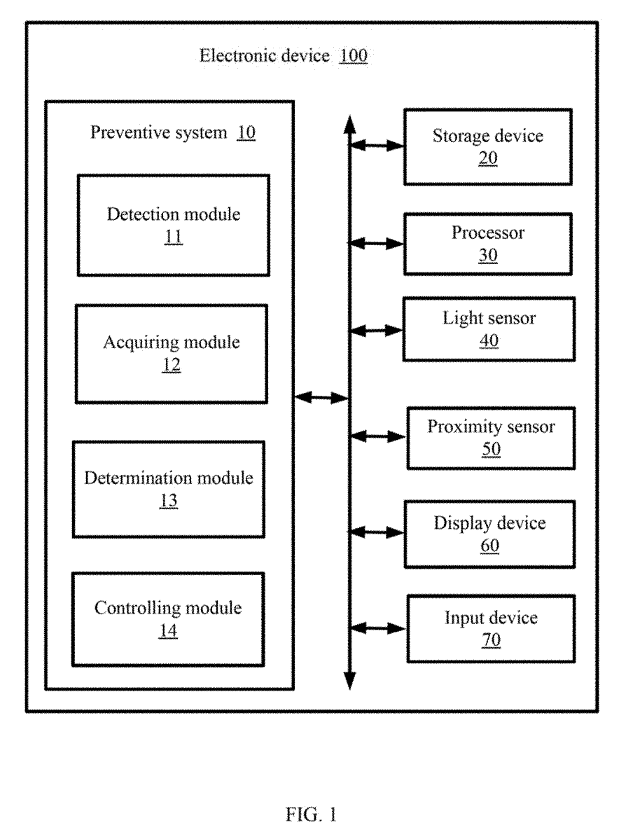

FIG. 1 shows an exemplary embodiment of an electronic device 100 including a preventive system 10 to avoid unintended operations. The preventive system 10 can transmit a prompt when the electronic device 100 triggers a unintended operation. Details will be provide in the following paragraphs.

Depending on the exemplary embodiment, the electronic device 100 can include, but is not limited to, a storage device 20, at least one processor 30, a light sensor 40, at least one proximity sensor 50, a display device 60, and an input device 70. The above components communicate with each other through a system bus. The electronic device 100 can be a smart phone, a personal digital assistant (PDA), a tablet computer, or any other suitable electronic device. FIG. 1 illustrates only one example of the electronic device 100 that can include more or fewer components than illustrated, or have a different configuration of the various components in other exemplary embodiments.

The storage device 20 can be an internal storage device, such as a flash memory, a random access memory (RAM) for temporary storage of information, and/or a read-only memory (ROM) for permanent storage of information. The storage device 20 can also be an external storage device, such as an external hard disk, a storage card, or a data storage medium.

In at least one exemplary embodiment, the at least one processor 30 can be a central processing unit (CPU), a microprocessor, or other data processing chip that performs functions for the electronic device 100. In at least one exemplary embodiment, the at least one processor 30 can be internally configured in the electronic device 100. In another exemplary embodiment, the at least one processor 30 can be externally connected with the electronic device 100.

In at least one exemplary embodiment, the light sensor 40 can detect light intensity of an environment around the electronic device 100. In this exemplary embodiment, there is one light sensor 40, and the light sensor 40 is installed on a front surface of the electronic device 100. In another exemplary embodiment, there can be more than one light sensor 40, and the more than one light sensor 40 can be positioned on other surfaces of the electronic device 100, such as back surface, top surface, bottom surface, and/or side surfaces of the electronic device 100.

The at least one proximity sensor 50 can detect whether an object exists within a predetermined range from the electronic device 100. In at least one exemplary embodiment, the predetermined range can be a predetermined circle whose center is the position of the electronic device 100. The predetermined circle has a predetermined radius.

In at least one exemplary embodiment, the display device 60 can be a touch device, for example, the display device 60 can be a liquid crystal display (LCD) touch screen or an organic light-emitting diode (OLED) touch screen. The display device 60 can display user interfaces of the preventive system 10.

The input device 70 can be used to input data. In at least one exemplary embodiment, the input device 70 can be a physical keyboard or a virtual keyboard. In at least one exemplary embodiment, the display device 60 can be combined with the input device 70 to provide a touch screen.

In at least one exemplary embodiment, the preventive system 10 can include a detection module 11, an acquiring module 12, a determination module 13, and a controlling module 14. The modules 11-14 can include computer instruction in the form of one or more programs that may be stored in the storage device 20, and executed by the at least one processor 30.

In at least one exemplary embodiment, the detection module 11 can detect whether the electronic device 100 is in response to a predetermined operation. In at least one exemplary embodiment, the predetermined operation can be set by a user. In at least one exemplary embodiment, the predetermined operation can be an operation that requires fee. For example, the predetermined operation can include, but is not limited to, making a call, sending a text message, and generating data traffic.

In at least one exemplary embodiment, the acquiring module 12 can acquire light intensity around the electronic device 100 when the electronic device 100 is in response to the predetermined operation. The acquiring module 12 can acquire the light intensity from the light sensor 40.

In at least one exemplary embodiment, the determination module 13 can determine whether the acquired light intensity is less than a predetermined light intensity. When the acquired light intensity is less than the predetermined light intensity, the determination module 13 can determine that the electronic device 100 may be in a closed space such as in a pocket, in a box, or in a room. When the acquired light intensity is less than the predetermined light intensity, the controlling module 14 further can control the at least one proximity sensor 50 to detect whether an object presents within the predetermined range from the electronic device 100. When an object presents within the predetermined range from the electronic device 100, the determination module 13 can determine that the electronic device 100 is in the closed space, and determine that the predetermined operation is an unintended operation. In at least one exemplary embodiment, the predetermined range can be a predetermined circle whose center is the position of the electronic device 100. The predetermined circle has a predetermined radius. When the predetermined operation is determined to be the unintended operation, the controlling module 14 can control the electronic device 100 to suspend response to the predetermined operation and control the electronic device 100 to turn on a reminder mode.

In at least one exemplary embodiment, when the acquired light intensity is equal to or more than the predetermined light intensity, and/or the at least one proximity sensor 50 detects no object within the predetermined range from the electronic device 100, the determination module 13 can determine that the electronic device 100 is not in the closed space, and can determine that the predetermined operation is not an unintended operation. The controlling module 14 can control the electronic device 100 continues to response to the predetermined operation. In other words, the determination module 13 does not suspend the response to the predetermined operation.

In at least one exemplary embodiment, when the electronic device 100 includes two proximity sensors 50 such as a first proximity sensor and a second proximity sensor, the first proximity sensor 50 can be configured on a front surface of the electronic device 100, and the second proximity sensor 50 can be configured on a rear surface of the electronic device 100. When the first proximity sensor 50 detects that an object presents within the predetermined range from the electronic device 100 and the second proximity sensor 50 detects that an object presents within the predetermined range from the electronic device 100, the determination module 13 can determine that an object presents within the predetermined range from the electronic device 100, and determine that the electronic device 100 is in a closed space. In at least one exemplary embodiment, when the electronic device 100 includes only one proximity sensor 50, and the only one proximity sensor 50 is configured on the front surface of the electronic device 100, the determination module 13 can determine that an object presents within the predetermined range from the electronic device 100 and determine the electronic device 100 is in the closed space, when the only one proximity sensor 50 detects that an object presents within the predetermined range from the electronic device 100.

In at least one exemplary embodiment, the predetermined light intensity and the radius of the predetermined circle can be default values pre-stored in the storage device 20. The predetermined light intensity and the radius of the predetermined circle can be set by the user. For example, if a carrying container of the user is semi-translucent, the predetermined light intensity can be set as a higher value. If the carrying container of the user is big, the radius of the predetermined circle can be set as a bigger value (e.g., about 5-10 cm). If the carrying container of the user is small, the radius of the predetermined circle can be set as a smaller value (e.g., about 1-4 cm).

In at least one exemplary embodiment, when the electronic device 100 turns on the reminder mode, the electronic device 100 can play a predetermined ringtone with a maximum volume, and vibrate the electronic device 100 with a maximum amplitude. The predetermined ringtone can be a shrilling ring, or can be a ringtone configured by the user.

In at least one exemplary embodiment, the controlling module 14 can control the electronic device 100 to provide a first user interface for the user. The first user interface can be used to set at least one predetermined operation and at least one prompt corresponding to the at least one predetermined operation. The prompt can be a text message or a voice message. The acquiring module 12 can generate a relation table and record a relationship between the at least one predetermined operation and the at least one prompt using the relation table. The acquiring module 12 can store the relation table into the storage device 20. For example, when the predetermined operation is making a call, the corresponding prompt can be a voice message such as “Master, the call is going to dial, please check it”. When the predetermined operation is sending a text message, the corresponding prompt can be a voice message such as “Master, the text message is going to send, please check it”. When the predetermined operation is generating data traffic, the corresponding prompt can be a voice message such as “Master, the data traffic is going to generate, please check it”.

In at least one exemplary embodiment, the acquiring module 12 can acquire the prompt from the relation table when the response to the predetermined operation is suspended. The controlling module 14 can control the electronic device 100 to broadcast the acquired prompt in a voice form. For example, when the predetermined operation is making a call, the controlling module 14 can control the electronic device 100 to suspend making the call and broadcast the corresponding prompt “Master, the call is going to dial, please check it”. In other exemplary embodiments, the prompt can be displayed as words on the display device 60.

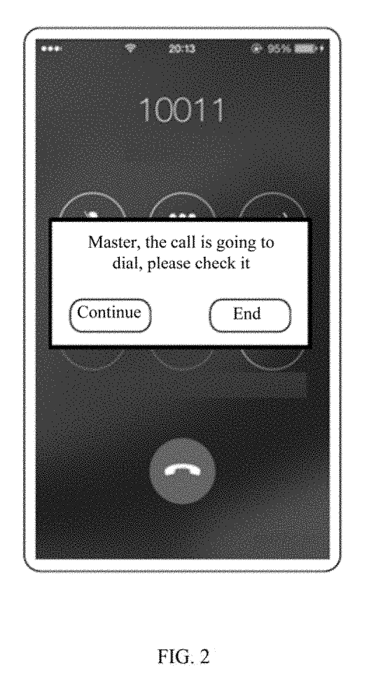

In at least one exemplary embodiment, the controlling module 14 further can provide a second user interface for the user to select whether the electronic device 100 continues to response to the predetermined operation. The response to the predetermined operation can be continuing executing the predetermined operation or stopping executing the predetermined operation. For example, when the predetermined operation is making the call, the second user interface can provide two selections for the user, as shown in FIG. 2. When the user selects to continue executing the predetermined operation, the controlling module 14 can control the electronic device 100 to answer the call. When the user selects to stop executing the predetermined operation, the controlling module 14 can control the electronic device 100 to hang up the call.

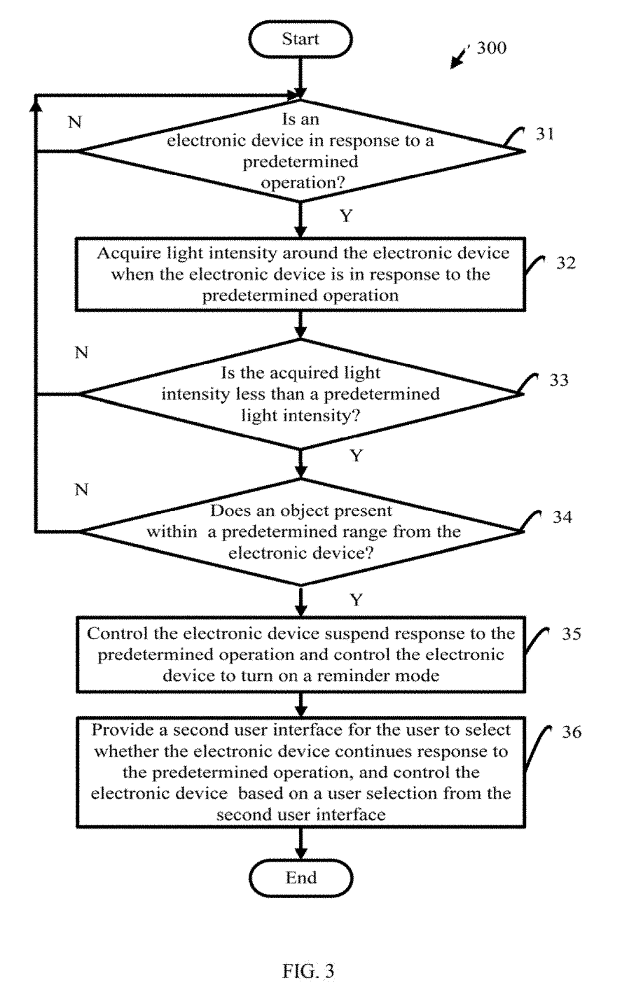

FIG. 3 illustrates a flowchart which is presented in accordance with an example exemplary embodiment. The example method 300 is provided by way of example, as there are a variety of ways to carry out the method. The method 300 described below can be carried out using the configurations illustrated in FIG. 1, for example, and various elements of these figures are referenced in explaining example method 300. Each block shown in FIG. 3 represents one or more processes, methods, or subroutines, carried out in the example method 300. Additionally, the illustrated order of blocks is by example only and the order of the blocks can be changed according to the present disclosure. The example method 300 can begin at block 31. Depending on the exemplary embodiment, additional steps can be added, others removed, and the ordering of the steps can be changed.

At block 31, the detection module 11 can detect whether the electronic device 100 is in response to a predetermined operation. When the electronic device 100 is in response to the predetermined operation, the process goes block 32. In at least one exemplary embodiment, the predetermined operation can be set by a user. In at least one exemplary embodiment, the predetermined operation can be an operation that requires fee. For example, the predetermined operation can include, but is not limited to, making a call, sending a text message, and generating data traffic.

At block 32, the acquiring module 12 can acquire light intensity around the electronic device 100 when the electronic device 100 is in response to the predetermined operation. The acquiring module 12 can acquire the light intensity from the light sensor 40.

At block 33, the determination module 13 can determine whether the acquired light intensity is less than a predetermined light intensity. When the acquired light intensity is less than the predetermined light intensity, the process goes to block 34. When the acquired light intensity is less than the predetermined light intensity, the determination module 13 can determine that the electronic device 100 may be in a closed space such as in a pocket, in a box, or in a room.

At block 34, the controlling module 14 further can control the at least one proximity sensor 50 to detect whether an object presents within the predetermined range from the electronic device 100. When an object presents within the predetermined range from the electronic device 100, the determination module 13 can determine that the electronic device 100 is in the closed space, and determine that the predetermined operation is an unintended operation, the process goes to block 35. In at least one exemplary embodiment, the predetermined range can be a predetermined circle whose center is the position of the electronic device 100. The predetermined circle has a predetermined radius.

In at least one exemplary embodiment, when the acquired light intensity is equal to or more than the predetermined light intensity, and/or the at least one proximity sensor 50 detects no object within the predetermined range from the electronic device 100, the determination module 13 can determine that the electronic device 100 is not in the closed space, and can determine that the predetermined operation is not an unintended operation. The controlling module 14 can control the electronic device 100 continues to response to the predetermined operation. In other words, the determination module 13 does not suspend the response to the predetermined operation.

In at least one exemplary embodiment, when the electronic device 100 includes two proximity sensors 50 such as a first proximity sensor and a second proximity sensor, the first proximity sensor 50 can be configured on a front surface of the electronic device 100, and the second proximity sensor 50 can be configured on a rear surface of the electronic device 100. When the first proximity sensor 50 detects that an object presents within the predetermined range from the electronic device 100 and the second proximity sensor 50 detects that an object presents within the predetermined range from the electronic device 100, the determination module 13 can determine that an object presents within the predetermined range from the electronic device 100, and determine that the electronic device 100 is in a closed space. In at least one exemplary embodiment, when the electronic device 100 includes only one proximity sensor 50, and the only one proximity sensor 50 is configured on the front surface of the electronic device 100, the determination module 13 can determine that an object presents within the predetermined range from the electronic device 100 and determine the electronic device 100 is in the closed space, when the only one proximity sensor 50 detects that an object presents within the predetermined range from the electronic device 100.

In at least one exemplary embodiment, the predetermined light intensity and the radius of the predetermined circle can be default values pre-stored in the storage device 20. The predetermined light intensity and the radius of the predetermined circle can be set by the user. For example, if a carrying container of the user is semi-translucent, the predetermined light intensity can be set as a higher value. If the carrying container of the user is big, the radius of the predetermined circle can be set as a bigger value (e.g., about 5-10 cm). If the carrying container of the user is small, the radius of the predetermined circle can be set as a smaller value (e.g., about 1-4 cm).

At block 35, when the predetermined operation is determined to the unintended operation, the controlling module 14 can control the electronic device 100 to suspend the response to the predetermined operation and control the electronic device 100 to turn on a reminder mode.

In at least one exemplary embodiment, when the electronic device 100 turns on the reminder mode, the electronic device 100 can play a predetermined ringtone with a maximum volume, and vibrate the electronic device 100 with a maximum amplitude. The predetermined ringtone can be a shrilling ring, or can be a ringtone configured by the user.

In at least one exemplary embodiment, the controlling module 14 can control the electronic device 100 to provide a first user interface for the user. The first user interface can be used to set at least one predetermined operation and at least one prompt corresponding to the at least one predetermined operation. The prompt can be a text message or a voice message. The acquiring module 12 can generate a relation table and record a relationship between the at least one predetermined operation and the at least one prompt using the relation table. The acquiring module 12 can store the relation table into the storage device 20. For example, when the predetermined operation is making a call, the corresponding prompt can be a voice message such as “Master, the call is going to dial, please check it”. When the predetermined operation is sending a text message, the corresponding prompt can be a voice message such as “Master, the text message is going to send, please check it”. When the predetermined operation is generating data traffic, the corresponding prompt can be a voice message such as “Master, the data traffic is going to generate, please check it”.

In at least one exemplary embodiment, the acquiring module 12 can acquire the prompt from the relation table when the response to the predetermined operation is suspended. The controlling module 14 can control the electronic device 100 to broadcast the acquired prompt in a voice form. For example, when the predetermined operation is making a call, the controlling module 14 can control the electronic device 100 to suspend making the call and broadcast the corresponding prompt “Master, the call is going to dial, please check it”. In other exemplary embodiments, the prompt can be displayed as words on the display device 60.

At block 36, the controlling module 14 further can provide a second user interface for the user to select whether the electronic device 100 continues to response to the predetermined operation. The controlling module 14 further can control the electronic device 100 based on a user selection from the second user interface. In at least one exemplary embodiment, the response to the predetermined operation can be continuing executing the predetermined operation or stopping executing the predetermined operation. For example, when the predetermined operation is making the call, the second user interface can provide two selections for the user, as shown in FIG. 2. When the user selects to continue executing the predetermined operation, the controlling module 14 can control the electronic device 100 to answer the call. When the user selects to stop executing the predetermined operation, the controlling module 14 can control the electronic device 100 to hang up the call.

It should be emphasized that the above-described exemplary embodiments of the present disclosure, including any particular exemplary embodiments, are merely possible examples of implementations, set forth for a clear understanding of the principles of the disclosure. Many variations and modifications can be made to the above-described exemplary embodiment(s) of the disclosure without departing substantially from the spirit and principles of the disclosure. All such modifications and variations are intended to be included herein within the scope of this disclosure and protected by the following claims.

What is claimed is:

1. A preventive method for an electronic device, the electronic device comprising a light sensor, at least one proximity sensor, and a storage device, the method comprising:
detecting whether the electronic device is in response to a predetermined operation;
acquiring light intensity around the electronic device from the light sensor when the electronic device is in response to the predetermined operation;
determining whether the acquired light intensity is less than a predetermined light intensity;
detecting whether an object presents within a predetermined range from the electronic device using the at least one proximity sensor, when the acquired light intensity is less than the predetermined light intensity; and
suspending the response to the predetermined operation and controlling the electronic device to turn on a reminder mode when an object presents within the predetermined range.

2. The method according to claim 1, further comprising:
providing a user interface for a user to select whether or not continues to response to the predetermined operation; and
controlling the electronic device based on a user selection from the user interface.

3. The method according to claim 2, wherein when the electronic device turns on the reminder mode, the electronic device plays a predetermined ringtone with a maximum volume, and/or vibrate the electronic device with a maximum amplitude.

4. The method according to claim 1, further comprising:
acquiring a prompt corresponding to the predetermined operation from a relation table which pre-stored in the storage device, wherein the relation table records a relationship between at least one predetermined operation and at least one prompt; and
controlling the electronic device to display the prompt as words on a display device of the electronic device or broadcast the prompt as voice.

5. The method according to claim 4, wherein the method further comprising:
providing a interface for setting the at least one predetermined operation and the at least one prompt;
generating the relation table to record the relationship between at least one predetermined operation and at least one prompt; and
storing the relation table into the storage device.

6. The method according to claim 1, wherein the predetermined operation comprises:
making a call, sending a text message, and/or generating data traffic.

7. An electronic device comprising:
a light sensor;
at least one proximity sensor;
at least one processor; and
a storage device stores one or more programs that, when executed by the at least one processor, cause the at least one processor to:
detect whether the electronic device is in response to a predetermined operation;
acquire light intensity around the electronic device from the light sensor when the electronic device is in response to the predetermined operation;
determine whether the acquired light intensity is less than a predetermined light intensity;
detect whether an object presents within a predetermined range from the electronic device using the at least one proximity sensor, when the acquired light intensity is less than the predetermined light intensity; and
suspend the response to the predetermined operation and controlling the electronic device to turn on a reminder mode when an object presents within the predetermined range.

8. The electronic device according to claim 7, wherein the at least one processor is further caused to:
provide a user interface for a user to select whether or not continues to response to the predetermined operation; and
control the electronic device based on a user selection from the user interface.

9. The electronic device according to claim 7, wherein when the electronic device turns on the reminder mode, the electronic device plays a predetermined ringtone with a maximum volume, and/or vibrate the electronic device with a maximum amplitude.

10. The electronic device according to claim 7, wherein the at least one processor is further caused to:
acquire a prompt corresponding to the predetermined operation from a relation table which pre-stored in the storage device, wherein the relation table records a relationship between at least one predetermined operation and at least one prompt; and
control the electronic device to display the prompt as words on a display device of the electronic device or broadcast the prompt as voice.

11. The electronic device according to claim 10, wherein the at least one processor is further caused to:
provide a interface for setting the at least one predetermined operation and the at least one prompt;
generate the relation table to record the relationship between at least one predetermined operation and at least one prompt; and
store the relation table into the storage device.

12. The electronic device according to claim 7, wherein the predetermined operation comprises: making a call, sending a text message, and/or generating data traffic.

13. A non-transitory storage medium having stored thereon instructions that, when executed by a processor of an electronic device, causes the processor to perform a preventive method, the electronic device comprising a light sensor, at least one proximity sensor, and a storage device, wherein the method comprises:
detecting whether the electronic device is in response to a predetermined operation;
acquiring light intensity around the electronic device from the light sensor when the electronic device is in response to the predetermined operation;
determining whether the acquired light intensity is less than a predetermined light intensity;
detecting whether an object presents within a predetermined range from the electronic device using the at least one proximity sensor, when the acquired light intensity is less than the predetermined light intensity; and
suspending the response to the predetermined operation and controlling the electronic device to turn on a reminder mode when an object presents within the predetermined range.

14. The non-transitory storage medium according to claim 13, wherein the method further comprises:
providing a user interface for a user to select whether or not continues to response to the predetermined operation; and
controlling the electronic device based on a user selection from the user interface.

15. The non-transitory storage medium according to claim 14 wherein when the electronic device turns on the reminder mode, the electronic device plays a predetermined ringtone with a maximum volume, and/or vibrate the electronic device with a maximum amplitude.

16. The non-transitory storage medium according to claim 13, wherein the method further comprises:
acquiring a prompt corresponding to the predetermined operation from a relation table which pre-stored in the storage device, wherein the relation table records a relationship between at least one predetermined operation and at least one prompt; and
controlling the electronic device to display the prompt as words on a display device of the electronic device or broadcast the prompt as voice.

17. The non-transitory storage medium according to claim 16, wherein the method further comprises:
providing a interface for setting the at least one predetermined operation and the at least one prompt;
generating the relation table to record the relationship between at least one predetermined operation and at least one prompt; and
storing the relation table into the storage device.

18. The non-transitory storage medium according to claim 16, wherein the predetermined operation comprises: making a call, sending a text message, and/or generating data traffic.
